(19) United States
(12) Patent Application Publication
(10) Pub. No.: US 2026/0352074 A1
(43) Pub. Date: Nov. 5, 2026

(54) METHOD FOR PRODUCING A STATOR FOR AN ELECTRIC MACHINE; STATOR FOR AN ELECTRIC MACHINE; AND FORMING TOOL

(71) Applicant: Schaeffler Technologies AG & Co. KG, Herzogenaurach (DE)

(72) Inventor: Markus Urbaschek, Wörth (DE)

(73) Assignee: Schaeffler Technologies AG & Co. KG, Herzogenaurach (DE)

(21) Appl. No.: 19/124,491

(22) PCT Filed: Sep. 29, 2023
(86) PCT No.: PCT/DE2023/100730

§ 371 Date: Apr. 25, 2025

(30) Foreign Application Priority Data
Oct. 26, 2022 (DE) 10 2022 128 288.0

(51) Int. Cl. H02K 15/33; B21F 1/00; H02K 3/52; H02K 15/022

(52) U.S. Cl. CPC H02K 15/33; B21F 1/002; H02K 3/522; H02K 15/022; H02K 2203/06

(57) ABSTRACT

A method for producing a stator for an electric machine, wherein in a first step, a coil carrier with regularly spaced teeth is provided, and then in a second step, a plurality of partial coils are wound onto the teeth, wherein the partial coils are connected to one another in groups towards an end face of the stator by means of connecting wires, wherein in a third step, at least one connecting wire is plastically deformed locally, forming an axially inwardly projecting loop region, wherein at the same time the connecting wire is tensioned in the circumferential direction of the stator. The invention also relates to a forming tool and a stator.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100730, filed on Sep. 29, 2023, designating the United States of America, which in turn claims the benefit of priority under 35 U.S.C. § § 119, 365 of German Patent Application No. 10 2022 128 288.0, filed on Oct. 26, 2022, the contents of which are relied upon and incorporated herein by reference in their entirety.

### FIELD OF THE DISCLOSURE

The disclosure relates to a method for producing a stator for an electric machine, wherein the electric machine is designed, for example, as a brushless DC motor, and in a first step a coil carrier with regularly (mutually) spaced teeth is provided and then in a second step a plurality of partial coils are wound onto the teeth, the partial coils being connected to one another in groups towards an end face (i.e., axial side) of the stator by means of connecting wires. The disclosure further relates to a stator produced by means of the method, as well as to a forming tool.

### BACKGROUND OF THE DISCLOSURE

WO 2020/057898 A1, DE 10 2015 211 836 A1 and DE 10 2018 222 891 A1 disclose various winding processes for producing a stator.

In the designs already known from the prior art, existing receiving devices for the stator windings are often relatively complex in design, requiring a relatively high number of additional components.

### SUMMARY OF THE DISCLOSURE

In some embodiments of the disclosure, at least one connecting wire is plastically deformed locally to form a loop region that projects axially inwards, and at the same time the at least one connecting wire is tensioned in the circumferential direction of the stator. An axially inwardly projecting loop region is to be understood in particular as a loop region which projects predominantly (possibly with a radial extension component) or exclusively (without a radial extension component) in the axial direction (i.e., along an axis of rotation of a rotor arranged to rotate relative to the stator) and extends in the direction of the stator body. In other words, the direction indication axially inwards is to be understood as meaning that the loop has an open, possibly narrowed region, from which the connecting wire extends from the two boundaries of the opening in the circumferential direction in an axial direction, and the axial direction is defined in relation to the end face of the stator such that a first axial direction points away from the end face of the stator and is defined as axially outward, while the opposite direction points from the end surface to the teeth, i.e., to the stator body, and is thus defined as axially inward. The closed side of the loop is thus spaced axially inward from the open region of the loop. Additional axial space is not necessary because of this loop region projecting axially inwards.

This increases the ease of manufacturing a compact stator coil.

Further advantageous embodiments of the disclosure are explained in more detail below.

In some embodiments, it is advantageous if the connecting wire with its loop regions is received in at least one axially open and circumferentially encircling receiving channel/cavity of the stator carrier. This results in the stator structure being simple.

Furthermore, it is advantageous if a plurality of loop regions are formed in a distributed manner in the circumferential direction on one connecting wire and/or in a distributed manner on a plurality of connecting wires. This makes it possible to individually adjust the tension of the connecting wires in a simple manner.

If there is at least one first loop region which projects in a first axial direction and at least one second loop region which projects in a second axial direction counter to the first axial direction, the loop regions are variably adjustable and can be integrated into existing installation spaces.

It can be particularly advantageous that both the first and the second loop region are each located axially within a winding space of the stator, wherein the winding space is axially delimited by the axially outermost tangential regions of the partial coils and connecting wires. In other words, the winding space is determined by the windings of the partial coils and connecting wires, which is present without loop regions. This means that the tangential windings, i.e., the windings in the circumferential direction, are present in this region, wherein there can be sections in the axial and/or radial direction between the individual tangential sections. However, there is an axially outer layer of windings, which represent an axial edge region of the winding space. Viewed from this edge region or axial boundary of the winding space, all windings, also the loop regions in the described case, lie exclusively in the axially inward direction. Exceptions to this may be the connection region of windings or connecting wires that connect the windings or connecting wires to connecting elements for connecting the stator to electric circuits. Such connection regions are expressly excluded from the loop regions according to the disclosure or do not contribute to the winding space.

It has also proven to be advantageous if the at least one loop region/each of the plurality of loop regions is produced by means of a manual pressing/squeezing process. This allows individual adjustment of the pre-tension in the connecting wire.

Thus, it is also expedient if the at least one loop region/each of the plurality of loop regions is formed by means of a mechanical forming tool. The forming tool is designed, for example, as a pair of pliers. This ensures efficient production of the stator. As an alternative to mechanical formation of the at least one loop region by means of a forming tool, it is also expedient if the at least one loop region is introduced automatically, for example by means of a robot (using the forming tool).

For efficient production of the electric machine, it is also advantageous if the coil carrier is received in a holding device as a linear (i.e., unrolled) structure in the second step. This means that the coil carrier is initially arranged in one plane in order to wind up the corresponding partial coils. This makes the wrapping process much easier.

Thus, it is again advantageous if the coil carrier is brought into an annular structure after the second step and before the third step. This allows at least one loop region to be skillfully introduced while producing sufficient tension.

Furthermore, the disclosure relates to a forming tool for forming a loop region on a stator coil, having two forming jaws which can be moved relative to one another in a predetermined deformation direction, wherein two pin-like first projections which are spaced apart from one another and each extend transverse to the deformation direction are arranged on a first forming jaw, and a pin-like second projection which also extends transverse to the deformation direction is arranged on a second forming jaw, wherein the forming jaws are designed such that the second projection can be pushed in and out of an intermediate space between the two first projections. However, it is not necessary for the forming jaws to move parallel to each other. Simpler or more complex relative movements between the forming jaws are also conceivable.

With regard to the forming tool, it is also expedient if the projections extend parallel to one another and/or perpendicular to the deformation direction. This results in a forming tool that is relatively easy to manufacture.

For a reproducible deformation, it is further advantageous if the first forming jaw has a guide groove between the first projections, into which guide groove a guide projection formed to be complementary to it can be inserted. The guide projection may extend to the guide groove in such a way that the guide projection and the guide groove are in sliding contact with one another when the forming jaws are in a certain (second) position relative to one another.

If the forming jaws directly form the jaws of a pair of pliers, the forming tool can be manufactured in an advantageously simple manner.

In some embodiments, the forming tool is intended for use in a method as described above.

The disclosure also relates to a stator.

The loop region, which projects axially inwards according to the disclosure, allows axial and radial installation space to be reduced.

In addition, loop regions that project axially outwards can also be provided. This allows a variable design of the loop region depending on the space available.

In a further development, it is possible for the stator to have a winding space which is delimited in the axial direction by the partial coils and the connecting wires, the axial boundary of the winding space being defined by the tangentially extending regions of the partial coils and connecting wires which are located axially outermost with respect to the stator. Possible axially extending connection regions do not contribute anything to this winding space.

The provided loop regions will then be formed axially within the winding space and not cross its axial boundary. This means that an axial extension of the end surface of the stator is not possible due to the loop regions, regardless of the axial direction in which they extend.

In a further development, it is then possible for the stator to be manufactured according to the method in accordance with one of the above-explained embodiments.

In other words, according to the disclosure, at least one axial loop (loop region), and, in various embodiments, a plurality of axial loops, is formed on connection wires of a linearly wound electric motor (electric machine). The protruding wires are bent in the axial direction, possibly in opposite directions (depending on the pole), in particular by means of pins (pin-like projections), so that loops (loop regions) are formed. These axial loops are located on the circumference of the motor and reduce the radial space requirement.

The disclosure will now be explained in more detail below with reference to figures.

### BRIEF DESCRIPTION OF THE DRAWINGS

In the drawings:

FIG. 1 shows a perspective view of a circumferential region of a stator for an electric machine produced according to the disclosure in accordance with a first exemplary embodiment, in which two (first) loop regions formed on a connecting wire can be clearly seen;

FIG. 2 shows a perspective view of a further circumferential region of the stator according to FIG. 1, in which a second loop region can be seen which projects counter to the first loop regions;

FIG. 3 shows a plan view of a holding device used to manufacture the stator according to the disclosure, in which a plurality of partial coils are already wound on a linearly arranged coil carrier;

FIG. 4 shows a plan view of a stator according to the disclosure in an intermediate state of production, in which the connecting wires have not yet been plastically deformed to form the loop regions, but the various locations at which the loop regions are to be introduced have already been marked;

FIG. 5 shows a plan view of a forming tool used to form a loop region with a connecting wire already inserted, the forming tool being in a first position in which the connecting wire is not yet plastically deformed;

FIG. 6 shows a plan view of the forming tool of FIG. 5, in which the forming tool is in a second position in which two forming jaws of the forming tool are pushed into each other and thus the connecting wire is plastically deformed to form a loop region;

FIG. 7 shows a perspective view of a forming tool according to the disclosure in the region of its forming jaws;

FIG. 8 shows a plan view of a forming tool according to the disclosure, which clearly shows its design as a pair of pliers;

FIG. 9 shows a flowchart to illustrate a production method according to the disclosure.

The figures are merely schematic in nature and serve solely for understanding the disclosure. Identical elements are provided with the same reference signs.

### DETAILED DESCRIPTION

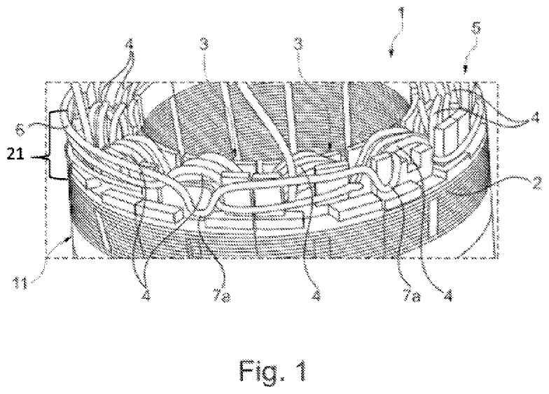

A stator 1 produced according to the disclosure is illustrated in connection with FIGS. 1, 2, and 4. The stator 1 is part of an electric machine (also referred to as an electric motor) which is not shown further for the sake of clarity. The electric machine may be designed as a brushless DC motor. In addition to the annular stator 1, the electric machine conventionally has a rotor arranged radially (radial is a direction perpendicular to an axis of rotation of the rotor) within the stator 1. The rotor can in turn be connected or is already connected conventionally to an output shaft protruding axially (axial is the direction along/parallel to the axis of rotation of the rotor) from the stator 1 in order to drive further components during operation, such as in a drive train of a motor vehicle.

The production of the stator 1 according to the disclosure is shown in general in FIG. 9 and in detail in connection with FIGS. 1 to 6. To produce the stator 1, a coil carrier 2 is first provided (in a first step a)) as shown in FIG. 3. The coil carrier 2 is initially linear, i.e., unwound. The coil carrier 2 is received on a holding device 9 according to FIG. 3 for winding a coil arrangement/stator coil.

Subsequently (in a second step b)), the coil arrangement is wound onto the coil carrier 2 in the form of a plurality of partial coils 4. The coil carrier 2 has a plurality of teeth 3 which are arranged next to one another at regular intervals along its linear structure 10 in FIG. 3. A partial coil 4 is wound on each tooth 3, and the partial coils 4 merge into one another/are connected to one another in groups, depending on how the stator is connected, and form a higher-level stator coil.

FIG. 3 also clearly shows that after winding of the coil carrier 2, a plurality of connecting wires 6 (copper wires), which serve to connect the partial coils 4 associated with a group, protrude towards a later end face 5/axial side of the stator 1 and extend at least partially along the (here linear) extension of the coil carrier 2.

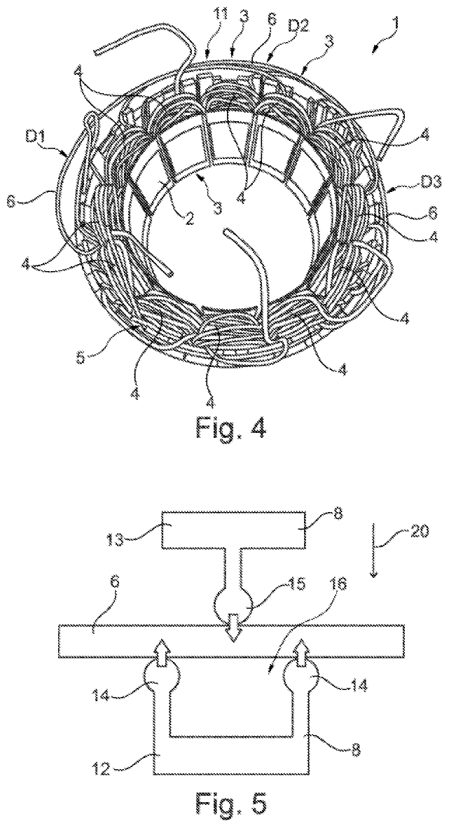

After the winding process of the partial coils 4 as shown in FIG. 3, the coil carrier according to FIG. 4 is brought into its annular structure 11 intended for use in the electric machine. As a result, the connecting wires extend in a circumferential direction of the stator 1 and are positioned accordingly.

Subsequently, in a third step c) of the method according to the disclosure, the connecting wires 6, which connect the partial coils 4 to one another in groups, are locally plastically deformed, whereby they are automatically pre-tensioned in the circumferential direction.

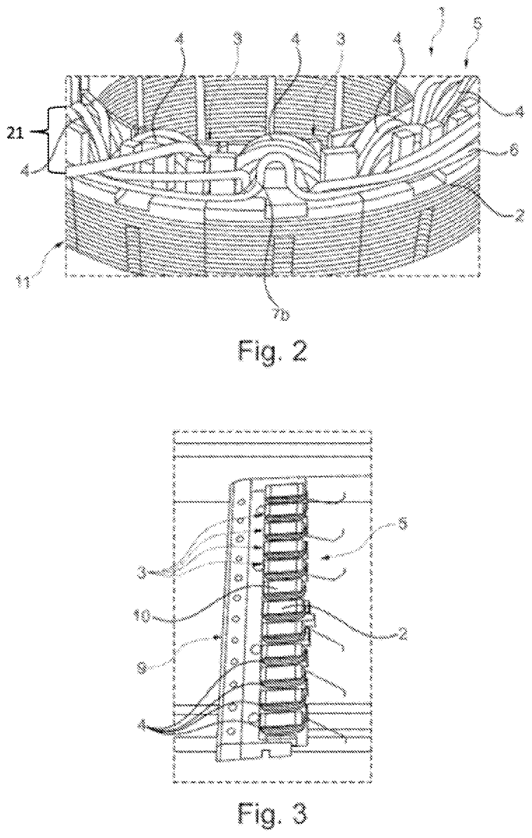

A plurality of loop regions 7a, 7b which have been specifically introduced by this plastic deformation can be clearly seen in FIGS. 1 and 2. Here, two first loop regions 7a on a single connecting wire 6 are shown in FIG. 1. These two loop regions 7a extend in a first axial direction of the stator 1 and lie radially from the outside directly on the coil carrier 2. It should be emphasized that the axial extension of the loop regions 7a lies within a winding space 21, i.e., no additional axial installation space is taken up by the loop regions 7a. The winding space 21 is delimited outwards in the axial direction by the tangential regions of the partial coils 4 and the connecting wires 6.

A second loop region 7b is shown in FIG. 2, which extends in a second axial direction counter to the first axial direction. The second loop region 7b is arranged on a further connecting wire 6 and also rests radially from the outside on the coil carrier 2. In this case also, the second loop region 7b is always disposed axially within the winding space 21.

In this way, the loop regions 7a, 7b are formed on the respective connecting wires at the locations D1, D2 and D3 of the stator shown in FIG. 4. This results in a radial pre-tensioning and a displacement of the other connecting wires 6 or their sections in the radial direction inwards. This results in complete contact of the connecting wires 6 in a radial direction from the outside with the coil carrier 2.

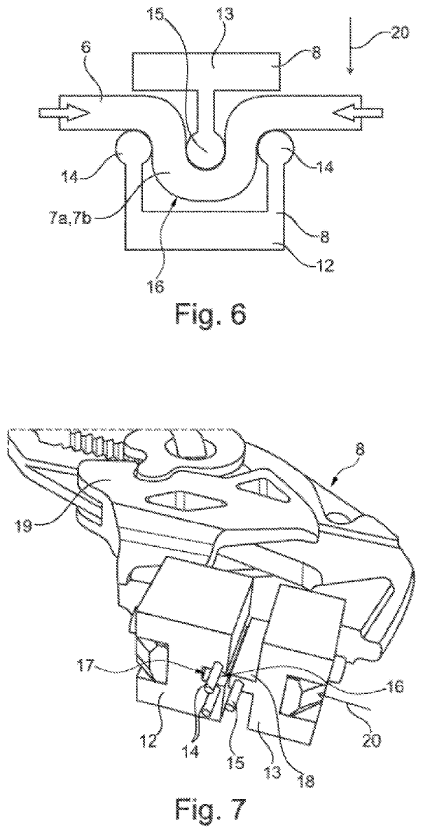

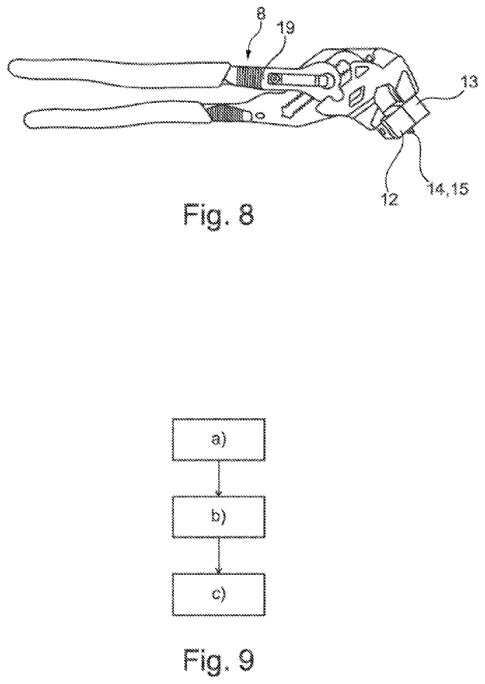

FIGS. 5 and 6 schematically illustrate a deformation process of the connecting wires 6, i.e., for forming the loop regions 7a, 7b. The forming process is carried out by means of a forming tool 8, which is shown below in FIGS. 7 and 8 in more detail.

According to FIG. 5, the forming tool 8 is first applied in a first position to the connecting wire 6 so that the connecting wire 6 is disposed between, on the one hand, two first projections 14 of a first forming jaw 12 of the forming tool 8 and, on the other hand, a second projection 15 of a second forming jaw 13 of the forming tool 8. For plastic deformation, the forming tool 8 (i.e., the forming jaws 12, 13 relative to each other) is moved into a second position. The forming jaws 12, 13 are moved/pressed towards each other from the first position to the second position in such a way that a loop region 7a, 7b is formed.

It can be seen that the two pin-like first projections 14 of the first forming jaw 12, which extend parallel to one another, are spaced apart from one another in such a way that the pin-like second projection 15 of the second forming jaw 13, which extends parallel to the first projections 14, can be moved/pushed into an intermediate space 16 between the two first projections 14, with the connecting wire 6 interposed. The distance between the facing sides of the projections 14, 15 is thus equal to or greater than the sum of the dimensions of the diameter of the second projection 15 and twice the diameter of the connecting wire 6.

Thus, the forming tool 8 can be moved between a first position, shown in FIG. 5, and a second position, shown in FIG. 6.

FIGS. 7 and 8 illustrate the forming tool 8 in more detail in an exemplary embodiment. The forming tool 8 is designed as a plier tool/a pair of pliers 19 and is directly equipped with the forming jaws 12, 13 on its jaws. The forming jaws 12, 13, thus, can be moved in the method in a deformation direction 20 from the first position to the second position and back again. The first and second projections 14, 15 protrude perpendicular to this deformation direction 20 and to a common side of the forming jaws 12, 13.

It can also be seen that a guide groove 17, extending parallel to the first projections 14, in the form of a slot is also introduced in the first forming jaw 12 between the first projections 14, i.e., in the intermediate space 16. A guide projection 18 complementary to this guide groove 17 is formed on the second forming jaw 13. If the forming tool 8 is closed, i.e., moved from the first position according to FIG. 5 to the second position according to FIG. 6, the guide projection 18 is pushed into the guide groove 17 so as to realize a sliding guide between the forming jaws 12, 13. The second projection 15 can be formed directly on the end face of the guide projection 18.

For the sake of completeness, it should be noted that the forming tool 8 in exemplary embodiments, which are not shown here for the sake of brevity, is part of an automatic system, i.e., a robot which introduces the loop regions 7a, 7b in a fully automated manner. However, the forming tool 8 also functions according to the principle explained above and is largely constructed in the same way.

In other words, according to the disclosure, the connection wires (connecting wires 6) are formed into axially and/or diagonally extending loops (loop regions 7a, 7b) using a suitable tool (forming tool 8). In this way, existing installation space can be used cleverly. The loops have the advantage that their plastic deformation puts tension on the connection wire and therefore reduces resilience. This makes the installation space requirement even smaller.

A manual tool (forming tool 8) can be used to apply the procedure. It is contemplated, however, that a fully automatic machine/system comprising a forming tool 8 according to the same principle may be used.

The tool is used to deform the connection wires, which consists, for example, of a plurality of pins (projections 14, 15) that can be moved against each other. One jaw of the tool may contain two pins, an opposite jaw contains a single pin, and the single pin is arranged centrally between the other two. By opening and closing the pair of pliers, the pins move relative to each other. A wire/connection wire clamped between them is thereby specifically bent into the U-shaped loop.

The same principle can also be used as a forming tool 8 of a fully automatic machine, but here the movement can be realized by compressed-air cylinders and corresponding joints/guides, and the forming sequence is specified by the controller of the assembly system.

### LIST OF REFERENCE SIGNS

1 Stator
2 Coil carrier
3 Tooth
4 Partial coil
5 End face
6 Connecting wire
7a First loop region
7b Second loop region
8 Forming tool
9 Holding device
10 Linear structure
11 Annular structure
12 First forming jaw
13 Second forming jaw
14 First projection
15 Second projection
16 Intermediate space
17 Guide groove
18 Guide projection
19 Pliers
20 Deformation direction
21 Winding space

1. A method for producing a stator for an electric machine, comprising the steps of:
providing a coil carrier with regularly spaced teeth;
winding a plurality of partial coils onto the teeth, wherein the partial coils are connected to one another in groups towards an end face of the stator by connecting wires; and
plastically deforming at least one connecting wire to simultaneously form an axially inwardly projecting loop region and tension the at least one connecting wire in a circumferential direction of the stator.

2. The method of claim 1, wherein a plurality of loop regions are formed in a distributed manner in the circumferential direction on the at least one connecting wire and/or in a distributed manner on a plurality of the connecting wires.

3. The method of claim 1, wherein at least one first loop region is provided which projects in a first axial direction and at least one second loop region is provided which projects in a second axial direction counter to the first axial direction.

4. The method of claim 3, wherein both the first and the second loop region are each located axially within a winding space of the stator, and wherein the winding space is axially delimited by axially outermost tangential regions of the partial coils and connecting wires.

5. The method of claim 1, wherein the loop region is formed via a mechanical forming tool.

6. The method of claim 1, wherein in the step of winding the plurality of partial coils onto the teeth, the coil carrier is received in a holding device as a linear structure.

7. A stator for an electric machine, comprising:
a coil carrier that includes a plurality of regularly spaced teeth;
a plurality of partial coils wound on the teeth; and
a plurality of connecting wires for connecting partial coils, wherein at least one connecting wire forms an axially inwardly projecting loop region.

8. The stator of claim 7, wherein at least one of the plurality of connecting wires locally forms a loop region which projects axially outwards.

9. (canceled)

10. (canceled)

11. A forming tool for forming a loop region on a stator coil, comprising:
a first forming jaw having two first projections extending outward therefrom such that an intermediate space is defined between the two first projections; and
a second forming jaw having a second projection extending outward therefrom, wherein at least one of the first forming jaw and the second forming jaw is movable relative to the other in a predetermined deformation direction to allow the second projection to enter the intermediate space, the first projections extend from the first forming jaw transversely to the deformation direction, and the second projection extends from the second forming jaw transversely to the deformation direction.

12. The forming tool of claim 11, wherein the first projections and the second projection extend parallel to each other.

13. The forming tool of claim 11, wherein the first forming jaw has a guide groove between the first projections, into which a complementary guide projection is configured to be inserted.

14. The forming tool of claim 11, wherein the first and second forming jaws are jaws of a pair of pliers.

15. The stator of claim 8, wherein the axially inwardly projecting loop region and the loop region that projects axially outwards are located axially within a winding space of said stator, and wherein the winding space is axially delimited by axially outermost tangential regions of the partial coils and the connecting wires.

16. The stator of claim 7, wherein the plurality of connecting wires form a plurality of axially inwardly projecting loop regions that are distributed circumferentially along the plurality of connecting wires.

17. The stator of claim 7, wherein the at least one connecting wire forms a plurality of axially inwardly projecting loop regions that are distributed circumferentially along the at least one connecting wire.

18. The method of claim 5, wherein the mechanical forming tool comprises:
a first forming jaw having two first projections extending outward therefrom, such that an intermediate space is defined between the two first projections; and
a second forming jaw having a second projection extending outward therefrom.

19. The method of claim 18, wherein at least one of the first forming jaw and the second forming jaw is movable relative to the other in predetermined deformation direction to allow the second projection to enter the intermediate space.

20. The method of claim 19, wherein the first projections extend from the first forming jaw transversely to the deformation direction.

21. The method of claim 20, wherein the second projection extends from the second forming jaw transversely to the deformation direction.

22. The method of claim 21, wherein the first projections and the second projection extend parallel to each other.
